(19) United States
(12) Patent Application Publication
(10) Pub. No.: US 2023/0153459 A1
(43) Pub. Date: May 18, 2023

(54) DEIDENTIFYING CODE FOR CROSS-ORGANIZATION REMEDIATION KNOWLEDGE

(71) Applicant: Veracode, Inc., Burlington, MA (US)

(72) Inventors: Asankhaya Sharma, Singapore (SG); Hao Xiao, Singapore (SG); Hendy Heng Lee Chua, Singapore (SG); Darius Tsien Wei Foo, Singapore (SG)

(21) Appl. No.: 17/754,194

(22) PCT Filed: Nov. 10, 2020
(86) PCT No.: PCT/US2020/059775

§ 371 Date: Mar. 25, 2022

(51) Int. Cl. G06F 21/62; G06F 8/40

(52) U.S. Cl. CPC G06F 21/6245; G06F 8/40

(57) ABSTRACT

To preserve privacy when leveraging organization-specific remediation knowledge for flaw remediation across organizations, program code is deidentified to remove code which potentially identifies its source/origin. Deidentification operates based on structure of flaws and fixes at the level of source code constructs based on an abstract syntax tree (AST) or other structural context representation of a fix and corresponding flaw. Potentially identifying portions of a fix indicated in its AST are determined and modified (e.g., removed or obfuscated) without impacting AST structure. Deidentified remediation knowledge originating from different organizations is used to train a fix suggestion model(s) which learns structural context of fixes and corresponding flaws and, once trained, generates predictions indicating suggested fixes to flaws based on structural contexts of the flaws. Deidentification can occur before training of the fix suggestion model(s) or during prediction so potentially identifying program code is removed before suggested fixes are consumed by different organizations.

### TECHNICAL FIELD

The disclosure generally relates to the field of software development, installation and management and to testing or debugging.

### BACKGROUND ART

Automated program repair techniques aim to reduce manual debugging efforts through automation of patch generation to fix flaws identified in program code, such as those related to bugs or security vulnerabilities. Automated patch generation often leverages analysis of potential fix patterns, or high-level modifications to program code as a result of applying a patch, to determine those which can remediate an identified flaw. For instance, in the generate-and-validate approach to automated patch generation, candidate patches corresponding to a set of fix patterns are applied to program code containing a flaw, and the program is evaluated using a series of tests to determine which of the candidate patches applied to the program successfully fixes the identified flaw.

### BRIEF DESCRIPTION OF THE DRAWINGS

Embodiments of the disclosure may be better understood by referencing the accompanying drawings.

FIG. 1 is a system diagram illustrating a remediation service that provides deidentified fix suggestions for flaws identified in a software project.

FIG. 2 depicts an example conceptual diagram of training a fix suggestion pipeline with deidentified flaw/fix training data.

FIG. 3 depicts an example conceptual diagram of determining fix suggestions for flaws based on output of a trained fix suggestion pipeline and deidentifying the fix suggestions.

FIG. 4 is a flowchart of example operations for deidentifying code for cross-organization remediation knowledge.

FIG. 5 is a flowchart of example operations for training a fix suggestion pipeline that generates deidentified code flaw fix suggestions.

FIG. 6 is a flowchart of example operations for obtaining and deidentifying fix suggestions from a trained fix suggestion pipeline.

FIGS. 7-8 are a flowchart of example operations for deidentifying a fix based on its structural representation.

FIG. 9 depicts an example computer system with a remediation service that includes a code de-identifier.

### DESCRIPTION OF EMBODIMENTS

The description that follows includes example systems, methods, techniques, and program flows that embody aspects of the disclosure. However, it is understood that this disclosure may be practiced without these specific details. For instance, this disclosure refers to abstract syntax trees as illustrative examples of a data structure that captures structural context of program code. Aspects of this disclosure can use other intermediate representations to express or describe the structural context of program code, such as a control flow graph. In other instances, well-known instruction instances, protocols, structures and techniques have not been shown in detail in order not to obfuscate the description.

### OVERVIEW

Flaw remediation knowledge gathered from a particular organization may be useful to inform fix suggestions for flaws identified in program code within other organizations; however, the program code associated with the fixes (i.e., patches) may include information which is proprietary, sensitive, or otherwise private to the organization. For instance, naming conventions used in the organization's program code may reflect proprietary information. As a result, fixes identified from a scan and analysis of an organization's program code cannot be presented to members of external organizations without the potential for sharing the originating organization's private information.

A technique for deidentifying program code while maintaining its underlying structure has been developed that resolves the issue of preserving privacy in leveraging organization-specific remediation knowledge for flaw remediation across organizations. Deidentification of program code can be considered the removal of features which may identify the organization from which the program code originates. Collected and deidentified remediation knowledge originating from different organizations, or cross-organization remediation knowledge, can be used to train a fix suggestion model(s) which learns from structural context of fixes and corresponding flaws. Predictions generated by the trained fix suggestion model indicate suggested fixes to flaws identified in program code based on structural contexts of the flaws, where the suggested fixes can include deidentified fixes learned from any originating organization. Suggested fixes can thus be incorporated for flaw remediation across organizations regardless of source/origin of the fixes without sharing private information that may be reflected in the program code.

Deidentification of program code as disclosed herein operates based on structure of flaws and fixes, where structure of program code may be defined in terms of an abstract syntax tree (AST) or other structural representation which indicates structural context of a flaw or a flaw and its corresponding fix. Deidentification therefore can be performed at the level of individual constructs in source code represented in a structural context representation of the source code, such as an AST. This lower level of granularity at which program code is deidentified affords for preservation of structure of the program code that may otherwise be lost, such as if code were instead deidentified at the level of line numbers. Code deidentification is achieved through determining potentially identifying portions of a fix collected from an organization's program code indicated in the associated structural context representation and removing, obfuscating, or otherwise modifying the potentially identifying code at one of several stages before the fix is presented as a suggestion. Potentially identifying code can include program code which does not correspond to known or publicly accessible code units/elements, such as standard libraries or open source libraries, or naming conventions used by an organization. After potentially identifying code is determined based on the structural context representation associated with a fix, the determined code can be modified in a manner which does not impact the overall structure of the program code of the fix; that is, the structure underlying the structural context representation is unchanged as a result of deidentification of the fix. Deidentification can occur either before training of the fix suggestion model(s) or during prediction. When deidentification is implemented before training, flaws and corresponding fixes can be preprocessed to deidentify sensitive code while preparing the flaws and fixes to be used as training data. The fix suggestion model(s) is thus trained on deidentified flaws and fixes. For deidentification during prediction, fix predictions output by the trained fix suggestion model are deidentified before the fix predictions are presented as suggestions. In either case, potentially identifying code is modified to remove source identifying information, such as information identifying of an organization, before fixes are consumed by users within different organizations, thus allowing the remediation knowledge gained across organizations to be used to inform intra- as well as inter-organizational fix suggestions without compromising organizational privacy.

### EXAMPLE ILLUSTRATIONS

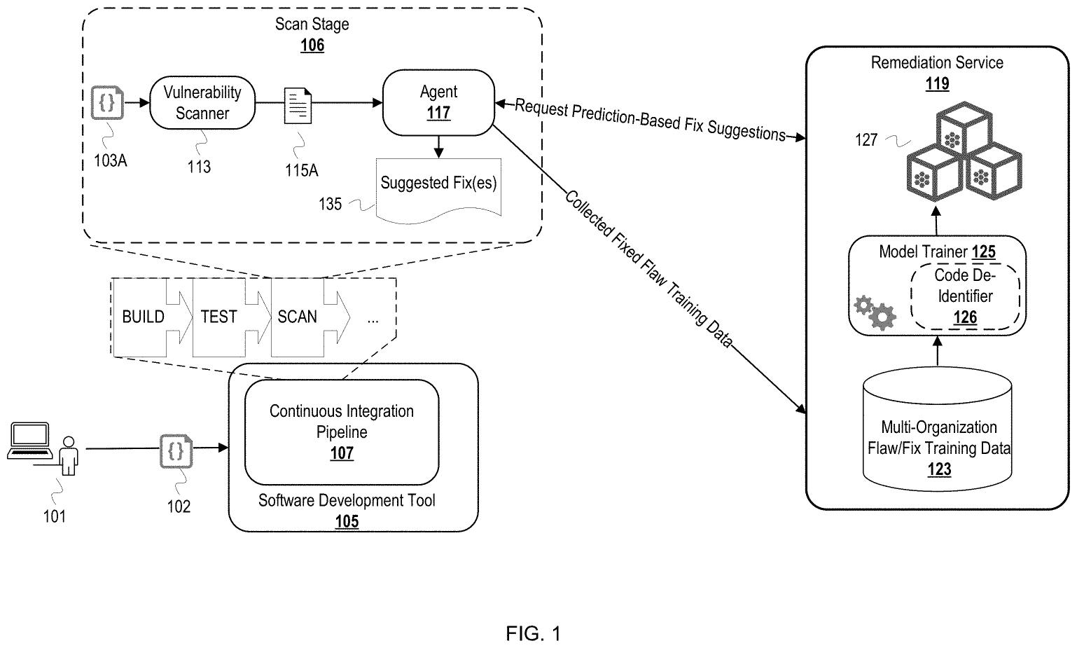

FIG. 1 is a system diagram illustrating a remediation service that provides deidentified fix suggestions for flaws identified in a software project. FIG. 1 depicts a remediation service 119 as communicating with a pipeline integrated agent. While embodiments can be used with various types of software development pipelines, FIG. 1 uses a continuous integration (CI) pipeline 107 as an example pipeline for the illustration. The CI pipeline 107 is implemented with a software development tool 105. An agent 117 can be program code integrated into the software development tool 105 or invoked from the software development tool 105, for example via an application programming interface (API). The remediation service 119 communicates with the agent 117 as part of providing deidentified fix suggestions.

During a software project, developers/engineers will submit code changes through a software development tool that implements a defined development pipeline. FIG. 1 illustrates a single instance of a developer 101 submitting a code change 102 for a software project with the software development tool 105 that implements the CI pipeline 107. Submission of a code change can be a commit, merge, push, etc., depending on the software development tool being used. The code change 102 may be program code being added to the software project or a revision/edit of program code existing in the software project. The submission of the code change 102 triggers running of the CI pipeline 107 as defined in a pipeline configuration file. The CI pipeline 107 has been defined to at least include a scan stage occurring after the build and test stages. The scan stage invokes a vulnerability scanner 113.

The agent 117 operates with scan results from the vulnerability scanner 113 to obtain fix suggestions for detected flaws. An initial input to the vulnerability scanner 113 is identified in FIG. 1 as program code 103A. The program code 103A may be the code change 102, an intermediate representation of the code change 102, or an intermediate representation of at least a part of the software project with the code change 102 incorporated. Inputting the program code 103A to the vulnerability scanner 113 generates scan results 115A. The scan results 115A indicate one or more flaws (e.g., vulnerabilities). The agent 117 obtains suggested fixes for the flaws identified in the scan results 115A by interacting with the remediation service 119. The agent 117 communicates or inputs the flaws to the remediation service 119 to obtain potential fixes output by one or more of trained models 127. The remediation service 119 includes the trained models 127, a repository 123 of multi-organization flaw/fix training data, and a model trainer 125. The trained models 127 have been trained with flaw/fix training data from the repository 123. The multi-organization flaw/fix training data is based on data from various sources, such as open source software repositories, peer organizations, etc. To allow for training with the multi-organization training data without exposing proprietary information, the model trainer 125 utilizes a code de-identifier 126. The code de-identifier 126 determines and modifies program code which is potentially identifying of its source organization, or the owning/controlling organization of the software project that is the source of the program code. Modifying program code refers to modifying the program code to remove source/organization identifying information. For example, an element of program code that includes information identifying of its source (e.g., its source organization) can be modified based on removing and optionally replacing the code element with another representation (e.g., a generic identifier or other abstracted representation) or obfuscating the code element.

After obtaining the potential fixes to the remaining flaws, the agent 117 presents the potential fixes as suggested fixes 135. The suggested fixes 135 have had potentially sensitive, private, or otherwise proprietary program code modified to produce a deidentified representation of the program code as a result of the model trainer 125 utilizing the code de-identifier 126 to deidentify training data used to generate the trained models 127. The suggested fixes 135 may thus include inter-organizational fixes, intra-organizational fixes, or a combination thereof. Presentation of the suggested fixes 135 can be implemented differently. The agent 117 can update the scan results 115A to include the suggested fixes 135. The agent 117 can pass the suggested fixes 135 in association with the corresponding remaining flaws to the software development tool 105 instance being used by the developer 101. The agent 117 may have its own user interface and present the suggested fixes 135 itself. In some implementations, the agent 117 can store the information or generate a notification of the suggested fixes 135.

The remediation service 119 can also communicate with the agent 117 to facilitate building of the repository 123. The agent 117 can provide to the remediation service 119 training data based on use of suggested fixes obtained from the remediation service 119, such as the suggested fixes 135, or other candidate fixes applied and determined to be successful. For instance, after the suggested fixes 135 are obtained from the remediation service 119, the agent 117 can present the flaws indicated in the scan results 115A in association with the suggested fixes. The agent 117 then detects which suggested fixes are selected for use and labels those for supervised training. Alternatively or in addition, the agent 117 may label other flaw/fix data identified by the developer 101 for supervised training based on the developer 101 accessing a commit log or other historical information maintained by the software development tool 105 and identifying fixes and corresponding flaws (e.g., upon the developer 101 determining that a previously-identified flaw has been remediated). The agent 117 can communicate the labelled training data to the remediation service 119 for insertion into the repository 123 at a configured cadence (e.g., every n commits, each selection, etc.). Labelled training data communicated to the remediation service 119 may be associated with an additional label, tag, identifier, etc. which indicates the source organization of the training data. Each entry in the repository 123 for flaw/fix data thus indicates its source organization based on the associated label, tag, identifier, etc.

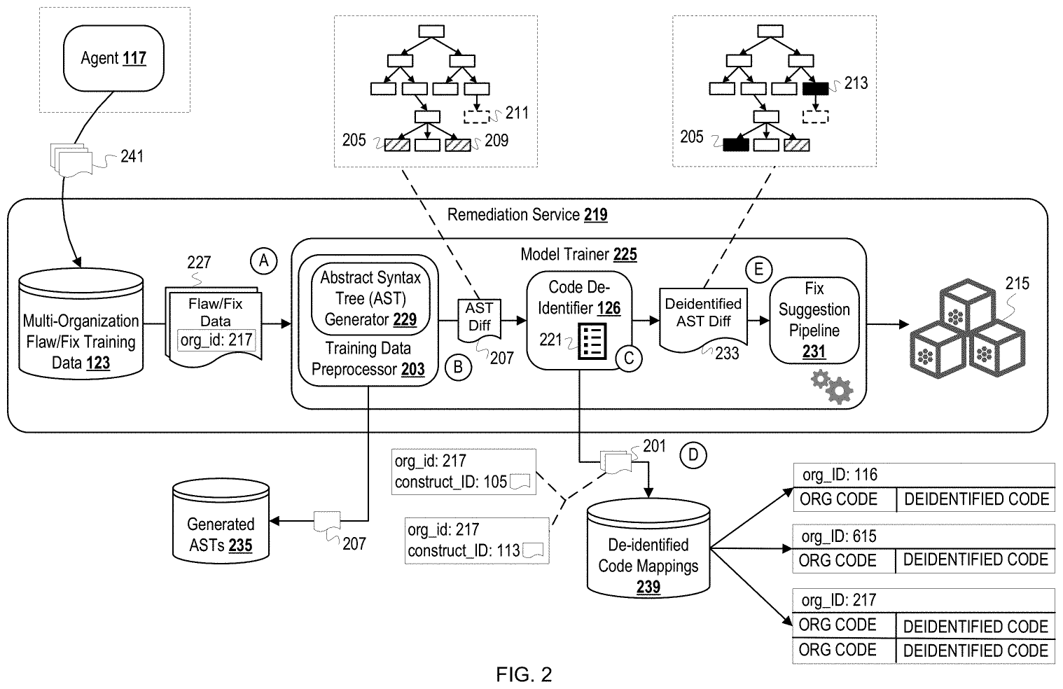

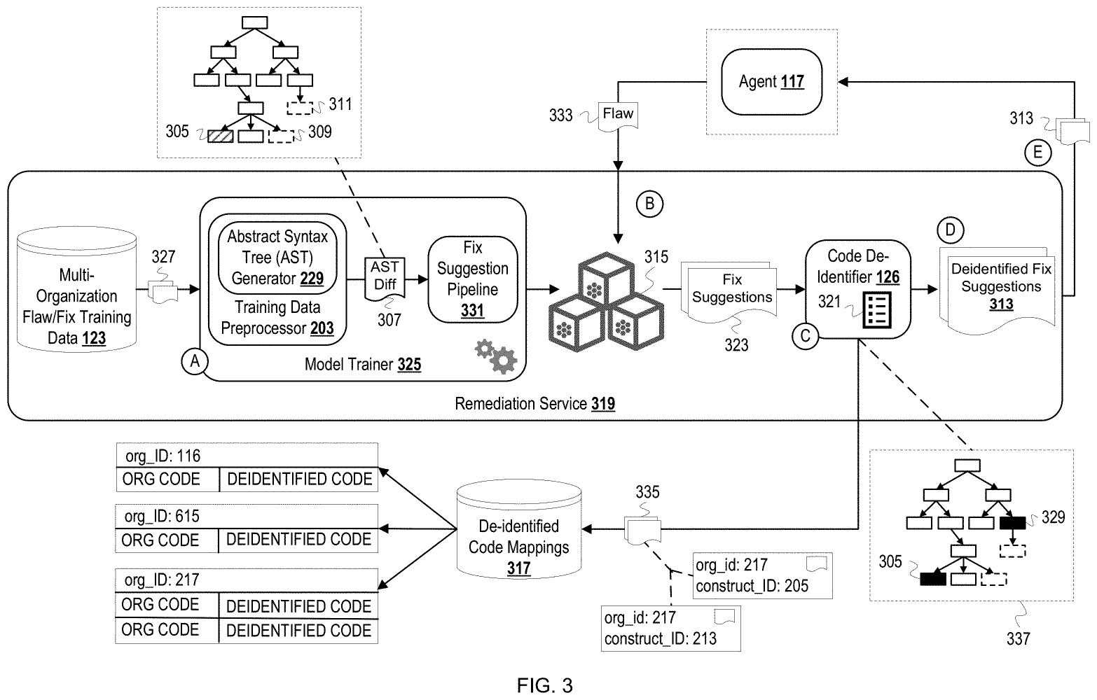

While FIG. 1 depicts the model trainer 125 as invoking the code de-identifier 126 to deidentify flaw/fix training data retrieved from the repository 123, in other implementations, the remediation service 119 invokes the code de-identifier 126 to deidentify the potential fixes output by the trained models 127 before the fixes are presented as suggestions. The code de-identifier 126 can thus be leveraged during preprocessing of the fixed flaw training data used to generate the trained models 127 (as depicted in FIG. 1) or after potential fixes have been output by the trained models 127 following a request for prediction-based fix suggestions. These implementations are now described in greater detail in reference to FIG. 2 and FIG. 3, respectively.

FIG. 2 depicts an example conceptual diagram of training a fix suggestion pipeline with deidentified flaw/fix training data. A remediation service 219 maintains the repository 123 of multi-organization flaw/fix training data. The remediation service 219 also includes a model trainer 225 which trains a machine learning model pipeline 231 comprised of one or more machine learning models, or the “fix suggestion pipeline 231,” with training data obtained from the repository 123 to generate a trained fix suggestion pipeline 215. The model trainer 225 utilizes the code de-identifier 126 to deidentify the training data obtained from the repository 123. The agent 117 communicates with the remediation service 219 to provide labelled training data 241 to the remediation service 219 for insertion into the repository 123 as similarly described above.

FIG. 2 is annotated with a series of letters A-E. These letters represent stages of operations. Although these stages are ordered for this example, the stages illustrate one example to aid in understanding this disclosure and should not be used to limit the claims. Subject matter falling within the scope of the claims can vary with respect to the order and some of the operations.

At stage A, the model trainer 225 retrieves labelled training data from the repository 123. The model trainer 225 retrieves flaw/fix data 227 which may comprise a source code file(s) of a flaw and a source code file(s) of its corresponding fix. Training data retrieved from the repository 123 can include flaw/fix data which originated from a software project owned by a particular organization or an open source software repository. Training data stored in the repository 123 which was collected from program code of a software project belonging to an organization may be assigned an identifier (ID) which uniquely identifies the respective source organization upon collection by the agent 117 or upon insertion into the repository 123. In this example, the flaw/fix data 227 is associated with a source organization with an organization ID of 217.

At stage B, the model trainer 225 invokes a training data preprocessor 203 to preprocess the flaw/fix data 227. The training data preprocessor 203 preprocesses flaw/fix training data to transform the data to a format which can be used as input to the fix suggestion pipeline 231 for training. Preprocessing flaw/fix data includes determining structural context of the flaw and corresponding fix, where structural context can be determined based on generating an AST for the flaw and fix. The training data preprocessor 203 utilizes an AST generator 229 to generate the AST based on determining a difference between source code of the flaw and source code of the fix and producing an AST diff 207 based on the resulting difference between the respective source code of the flaw and fix. The AST generated by the AST generator 229 is referred to herein as an “AST diff” due to the general correspondence with the code diff resulting from determining the difference between the flaw source code and fix source code. The AST diff 207 includes a plurality of nodes corresponding to source code constructs and may indicate additions or deletions made to the source code as a result of applying the fix to the flaw. In this example, the AST diff 207 includes a node 205 and a node 209 indicating constructs which were added and a node 211 indicating a construct which was deleted. Values of the source code constructs for each node (e.g., the corresponding syntax) may be denoted in nodes of the AST diff 207 as a node property, attribute, etc. The training data preprocessor 203 may assign the AST diff 207 an ID which identifies the fix represented by the flaw/fix data 227 and insert the AST diff 207 in a repository 235 maintained for storing AST diffs generated during training.

At stage C, the code de-identifier 126 obtains the AST diff 207 and deidentifies potentially identifying features of the flaw/fix data 227 indicated by the nodes of the AST diff 207. The code de-identifier 126 leverages rules 221 for determining code that is sensitive, proprietary, or otherwise potentially identifies the source organization of the flaw/fix data 227 being evaluated. The rules 221 indicate criteria for determining if a source code construct indicated by a node of the AST diff 207 corresponds to potentially identifying code. Criteria can include type, origin, and/or other features of source code constructs that potentially render the construct identifying of its source organization. For instance, the rules 221 may dictate that source code constructs which do not correspond to publicly accessible code elements/units (e.g., open source code units, standard code units, etc.) should be considered potentially identifying. Alternatively or in addition, the rules 221 may indicate that naming conventions, such as names assigned to variables, classes, routines/subroutines, or other constructs, are potentially identifying features. To determine the source code constructs of the flaw/fix data 227 which comprise potentially identifying code, the code de-identifier 126 evaluates the nodes of the AST diff 207 against the rules 221 and determines which of those correspond to potentially identifying code based on satisfying at least a first of the rules 221. The code de-identifier 126 may, for instance, iterate over each of the nodes of the AST diff 207 and evaluate an attribute or property value(s) of the node against the rules 221 to determine if the source code construct represented by the node satisfies a first rule of the rules 221. Nodes which the code de-identifier 126 determines to satisfy one of the rules 221 are selected for deidentification of the corresponding source code. In this example, the code de-identifier 126 determines that the node 205 and a node 213 satisfy the rules 221 and thus correspond to potentially identifying code.

To de-identify the source code corresponding to the nodes 205, 213, the code de-identifier 126 modifies the source code corresponding to the node. Modifying the source code results in a deidentified representation of the source code, or a representation in which the potentially identifying elements/constructs of the code are removed. The manner by which the source code is modified may be specified by a set of deidentification policies that are indicated in the rules 221, attached to (e.g., installed on or otherwise accessible to) the code de-identifier 126, etc. For instance, code may be modified by determining a generic identifier indicative of the type of the respective construct and replacing the construct with the generic identifier. As another example, code may be modified through obfuscation, such as by replacing the code with a string of randomly generated characters. Deidentification of the code represented by the nodes 205, 213 generates a deidentified AST diff 233 in which the potentially identifying features that were indicated in the AST diff 207 have been removed. Deidentification of potentially identifying code at the level of individual source code constructs represented in the AST diff 207 preserves of structure of the flaw/fix data 227, as the code de-identifier 126 does not modify the structure of the AST diff 207 when deidentifying the source code—that is, the AST diff 207 and deidentified AST diff 233 have the same structure.

At stage D, the code de-identifier 126 inserts mappings 201 which associate an indication of the deidentified source code corresponding to the nodes 205, 213 with an indication of their respective original representations into a repository 239 of de-identified code mappings. The repository 239 stores mappings between modified and original versions of program code determined to be potentially identifying of its source organization. The repository 239 can be indexed by organization ID or entries in the repository 239 can be labelled based on organization ID. The mappings 201 may each comprise an organization ID and a construct ID as well as an indication of the original and deidentified code, for example. By storing mappings between original and deidentified flaw/fix information, if a deidentified fix is suggested for a flaw appearing in code belonging to its source organization (i.e., the fix is an intra-organization fix), the original representation(s) of the deidentified portion(s) of the fix can be presented instead of the deidentified representation to facilitate understanding of suggested fixes by users consuming the suggestions and incorporation of the suggested fixes into the software project if an intra-organization fix suggestion is selected. For instance, the remediation service 219 could be configured to present original representations of fix suggestions determined to be intra-organization fixes based on accessing the repository 239 before returning the fix suggestions to the agent 117.

At stage E, the model trainer 225 provides the deidentified AST diff 233 as input to the fix suggestion pipeline 231 for training. Because the structure of the AST diff 207 was unchanged from the operations of the code de-identifier 126 which generated the deidentified AST diff 233, the model trainer 225 can train the fix suggestion pipeline 231 to learn structural context of flaws and their fixes, such as the flaw/fix data 227, as opposed to specific syntax of flaws and fixes. The model trainer 225 can continue to retrieve flaw/fix data from the repository 123, generate an AST diff based on the training data, deidentify the flaw/fix data based on the AST diff if the rules 221 are satisfied, and provide the deidentified AST diff as input into the fix suggestion pipeline 231 until one or more training criteria have been satisfied to yield the trained fix suggestion pipeline 215. Because the model trainer 225 trains the fix suggestion pipeline 231 based on ASTs which have been deidentified, the trained fix suggestion pipeline 215 generates predictions corresponding to deidentified fixes. Suggested fixes selected based on output of the trained fix suggestion pipeline 215 can thus be presented to users within any organization regardless of the source organization(s) of the suggested fixes.

FIG. 3 depicts an example conceptual diagram of determining fix suggestions for flaws based on output of a trained fix suggestion pipeline and deidentifying the fix suggestions. A remediation service 319 maintains the repository 123 of multi-organization flaw/fix training data. The remediation service 319 also includes a model trainer 325 which trains a fix suggestion pipeline 331 with training data obtained from the repository 123 to generate a trained fix suggestion pipeline 315. The agent 117 communicates with the remediation service 319 to obtain suggested fixes to one or more flaws by providing program code of the flaws as input to the trained fix suggestion pipeline 315. The remediation service 319 utilizes the code de-identifier 126 to deidentify suggested fixes output by the trained fix suggestion pipeline 315.

FIG. 3 is annotated with a series of letters A-E. These letters represent stages of operations. Although these stages are ordered for this example, the stages illustrate one example to aid in understanding this disclosure and should not be used to limit the claims. Subject matter falling within the scope of the claims can vary with respect to the order and some of the operations.

At stage A, the model trainer 325 trains the fix suggestion pipeline with labelled training data retrieved from the repository 123 to generate the trained fix suggestion pipeline 315. The model trainer 325 retrieves flaw/fix data from the repository 123, including labelled training data 327 that comprises flaw/fix data (e.g., flaw and fix source code files). Retrieval and preprocessing of labelled training data retrieved from the repository 123 by the model trainer 325 occurs as similarly described in reference to stages A and B of FIG. 2. In particular, the model trainer 325 invokes the training data preprocessor 203 to preprocess the labelled training data 327 based on determining structural context for the flaw and corresponding fix represented by the labelled training data 327, where structural context can be indicated by an AST for the labelled training data 327. The training data preprocessor 203 utilizes the AST generator 229 to generate an AST diff 307 based on determining a difference between source code of the flaw and source code of the fix. In this example, the AST diff 307 indicates the addition of a source code construct corresponding to a node 305 and deletion of source code constructs corresponding to a node 309 and a node 311. The model trainer 325 provides the AST diff 307 as input for training the fix suggestion pipeline 331. As similarly described in reference to FIG. 2, the fix suggestion pipeline 331 learns from structural context of flaw/fix data indicated by the AST diffs provided as input. The model trainer 325 continues training the fix suggestion pipeline 331 in this manner until one or more training criteria have been satisfied to yield the trained fix suggestion pipeline 315. In this example, the model trainer 325 is trained using original representations of flaw/fix data rather than deidentified flaw/fix data as described in reference to FIG. 2.

At stage B, the remediation service 319 obtains program code of at least a first flaw 333 from the agent 117. The flaw 333 can be a flaw detected by the agent 117 as a result of scanning a software project as described in reference to FIG. 1. The agent 117 can communicate flaws such as the flaw 333 to the remediation service 319 to request potential fixes or fix suggestions output by the trained fix suggestion pipeline 315 as a result of running the pipeline 315 with the flaws as input. The remediation service 319 can perform similar initial processing of the flaw 333 to generate an AST of the flaw 333 indicating structural context of the flaw before passing the flaw 333 as input to the trained fix suggestion pipeline 315. Running the trained fix suggestion pipeline 315 with the flaw 333 as input results in the fix suggestion pipeline 315 outputting one or more fix suggestions 323 as prediction results. The fix suggestions 323 comprise suggested fixes for the flaw 333 based on the structural context of the flaw 333. The fix suggestions 323 also include the original fix program code based on which the trained fix suggestion pipeline 315 was trained; that is, unlike the example depicted in FIG. 2, fix suggestions output by the trained fix suggestion pipeline 315 are not deidentified fixes.

At stage C, the code de-identifier 126 deidentifies potentially identifying code included in the fix suggestions 323. The code de-identifier 126 may first determine if one or more of the fix suggestions 323 are intra-organization fixes, such as based on whether an organization ID associated with the flaw 333 matches the organization ID associated with any of the fix suggestions 323. Intra-organization fixes may bypass deidentification so that the consuming organization is presented with the original representation of the fix as obtained from that organization's program code (i.e., the fix without deidentification). For each of the remaining fix suggestions 323, the code de-identifier 126 can deidentify the fix suggestion based on structural context of the fix suggestion. The code de-identifier 126 can determine structural context of each of the fix suggestions 323 based on determining an AST associated with the fix and evaluating nodes of the determined AST against rules 321 to determine code included in the fix that is potentially identifying of its respective source organization. As with the rules 221, the rules 321 may indicate one or more criteria for determining that a source code construct is potentially identifying of its source organization, such as type, origin, and/or other features of the construct. In this example, the code de-identifier 126 can obtain an AST previously created for each of the fix suggestions 323 during the training which resulted in the trained fix suggestion pipeline 315 based on an ID associated with the fix. For instance, a repository which the remediation service 319 can query by fix ID may store ASTs generated from flaw/fix data during training (e.g., as described in reference to FIG. 2 at stage B with respect to the repository 235). Determining the AST associated with the fix suggestions 323 can then comprise the remediation service 319 retrieving the ASTs corresponding to each of the fix suggestions 323 from the AST repository that was built/updated during training of the fix suggestion pipeline 331.

For each AST determined for the fix suggestions 323, the code de-identifier 126 evaluates the nodes of the AST against the rules 321 and determines whether any of the nodes correspond to potentially identifying code based on satisfying at least a first of the rules 321. The code de-identifier 126 may, for instance, iterate over each of the nodes of the AST and evaluate an attribute or property value(s) of the node against the rules 321 to determine if the source code construct represented by the node satisfies a first rule of the rules 321. Nodes which the code de-identifier 126 determines to satisfy one of the rules 321 are selected for deidentification of the corresponding source code. In this example, the code de-identifier 126 determines that the node 305 and a node 329 of a first determined AST satisfy the rules 321 and thus correspond to potentially identifying code. The code de-identifier 126 can then modify the source code corresponding to the nodes 305, 329, such as by obfuscating the source code or replacing the source code with a generic identifier (e.g., an identifier representing the type of the source code construct), to generate a deidentified representation of the source code. The manner by which the source code is modified may be specified by a set of deidentification policies that are indicated in the rules 321, installed on or otherwise accessible to the code de-identifier 126, etc. Deidentification of the AST(s) associated with the fix suggestions 323 produces a corresponding number of deidentified ASTs, including a deidentified AST 337. The code de-identifier 126 can then insert mappings 335 which associate an indication of the deidentified source code corresponding to the nodes 305, 329 with an indication of their respective original representations into a repository 317 of de-identified code mappings as similarly described in reference to FIG. 2. Mappings determined and stored during prediction stage deidentification may later be leveraged for retraining the fix suggestion pipeline 331 and/or for program debugging operations.

At stage D, the remediation service 319 determines deidentified fix suggestions 313 based on the deidentified AST(s) created by the code de-identifier 126. For instance, for the deidentified AST 337, the remediation service 319 can “reconstruct” the fix suggestion based on the deidentified AST 337 to result in the respective one of the deidentified fix suggestions 313. Reconstruction of fix suggestions can be considered transforming a deidentified AST to the source code which it represents to generate the corresponding deidentified fix suggestion, where deidentified source code constructs indicated in the deidentified AST are carried over into the deidentified fix suggestion. The deidentified fix suggestions 313 are thus deidentified versions of the fix suggestions 323 output by the trained fix suggestions pipeline 315.

At stage E, the remediation service 319 returns the deidentified fix suggestions 313 to the agent 117. The remediation service 319 may first determine the deidentified fix suggestions 313 having a source organization which is the same as the owning/controlling organization of the software project in which the flaw 333 was detected and are thus intra-organization fixes. Those of the deidentified fix suggestions 313 determined to be intra-organization fixes can be associated with a label or weight based before the remediation service 319 returns the deidentified fix suggestions 313 to the agent 117 to indicate which suggested fixes may have priority over the others.

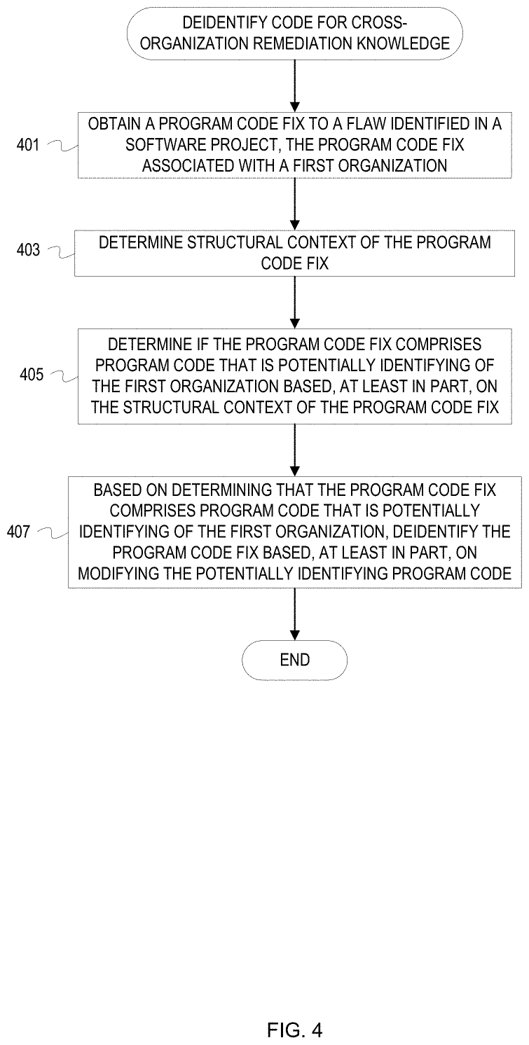

FIGS. 4-8 are flowcharts corresponding to example operations of a remediation service for deidentifying code for cross-organization remediation knowledge. Description of these example operations will refer to a remediation service as performing the example operations, where a code de-identifier can execute on the remediation service as described in reference to the earlier figures, but naming of the actor is for convenience. Naming and organization of program code can be arbitrary and can vary by platform, developer, etc. Further, some of the blocks in FIGS. 4-8 are depicted with dashed lines. Such blocks represent examples of operations that can be optionally performed, such as configurable settings of the remediation service. However, this depiction of the blocks should not be interpreted as the operations in the blocks depicted with solid lines being required operations.

FIG. 4 is a flowchart of example operations for deidentifying code for cross-organization remediation knowledge. FIG. 4 refers to the remediation service as performing the example operations.

At block 401, the remediation service obtains a program code fix to a flaw identified in a software project, where the program code fix is associated with a first organization. The remediation service may obtain the program code fix and identified flaw from training data used to train a fix suggestion machine learning model pipeline. In other examples, the remediation service may obtain the program code fix based on output of running a trained fix suggestion machine learning model pipeline with the identified flaw as input.

At block 403, the remediation service determines structural context of the program code fix. The remediation service can determine an AST of the program code fix and/or control flow graph of the program code fix. For instance, to determine the structural context represented by an AST, the remediation service may determine the AST based on differences between source code of the program code flaw and source code of the program code fix. In other examples, the remediation service may obtain a structural context previously determined for the program code fix (e.g., during training of a fix suggestion machine learning model pipeline).

At block 405, the remediation service determines if the program code fix comprises program code that is potentially identifying of the first organization based, at least in part, on the structural context of the program code fix. The remediation service evaluates the structural context to determine if any of the indicated code elements (e.g., AST nodes representing source code constructs) are potentially identifying of the first organization. For instance, potentially identifying program code can be determined based on code elements indicated in the structural context satisfying one or more rules, criteria, etc. for determining program code that could potentially identify its source. As an example, the rules or criteria may indicate that program code that does not correspond to an open source code unit(s) or standard code unit(s) and/or naming conventions are to be considered program code that is potentially identifying of its source.

At block 407, based on determining that the program code fix comprises program code that is potentially identifying of the first organization, the remediation service deidentifies the program code fix based, at least in part, on modifying the potentially identifying program code. The remediation service modifies the program code in a manner which removes the potentially identifying information which it includes. For instance, the potentially identifying program code can be modified through obfuscation, removal, removal and replacement with a placeholder or identifier, etc.

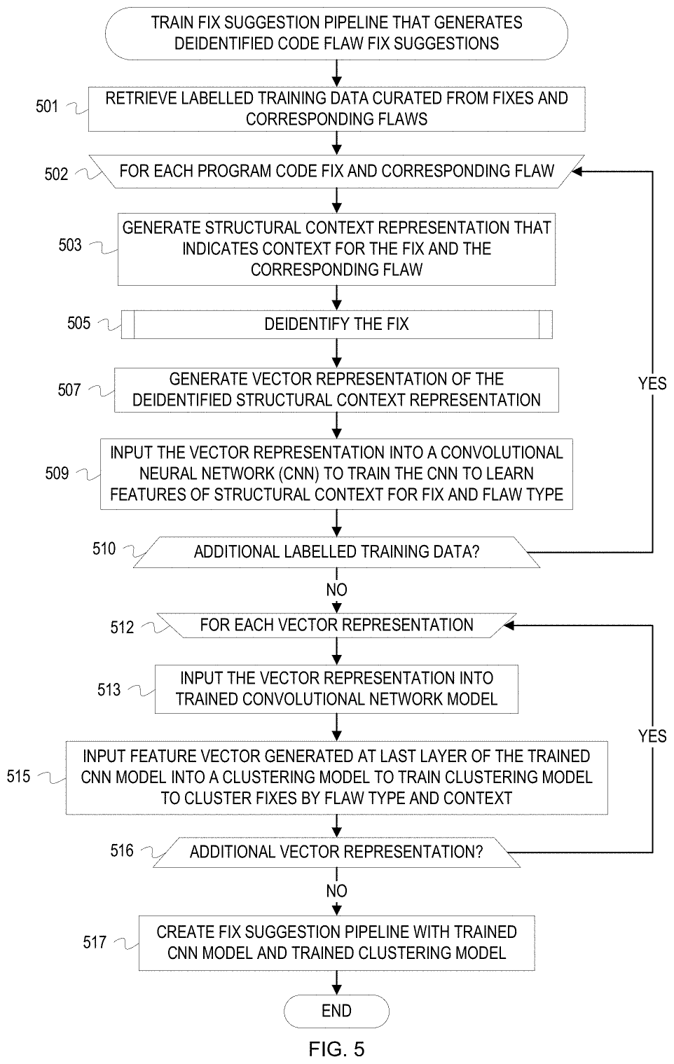

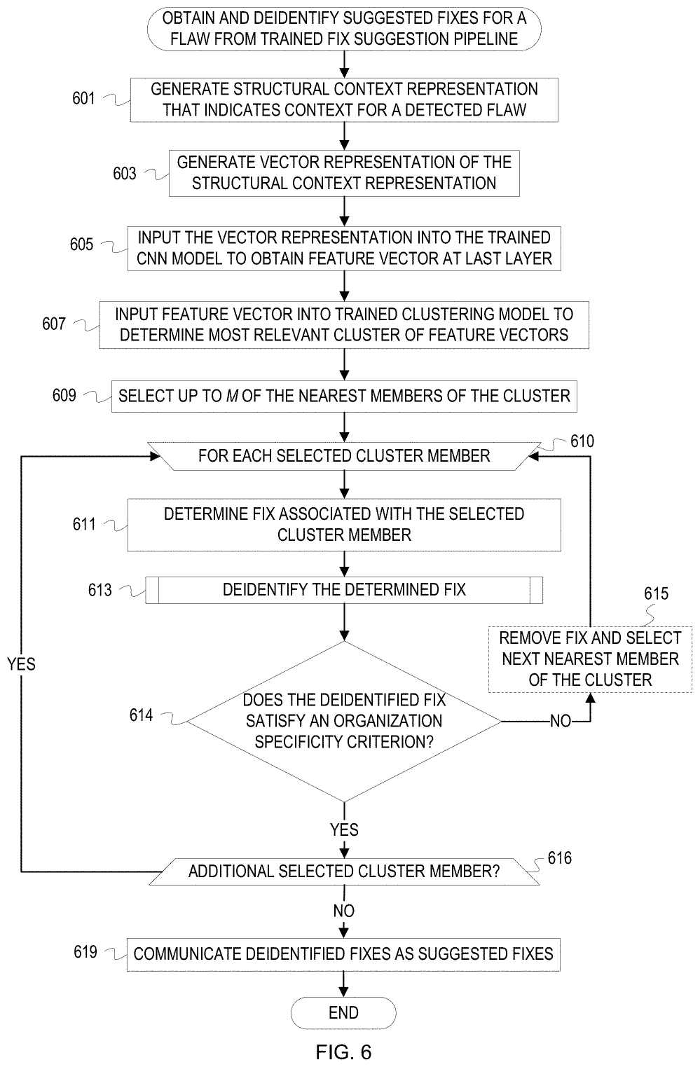

As mentioned above, the remediation service employs the machine learning model pipeline, or fix suggestion pipeline, to provide predicted fix suggestions. The fix suggestion pipeline is trained to learn structural context of different fixes across different types of flaws. The structural context can be described in terms of inheritance, variable declarations, calls, etc. Structural context for program code can be expressed with an AST or control flow graph. After learning features for different structural contexts, the fix suggestion pipeline is trained to cluster fixes by flaw type and structural context. FIGS. 5-6 are flowcharts of example operations for training the fix suggestion pipeline to generate fix suggestions and use the trained fix suggestion pipeline.

FIG. 5 is a flowchart of example operations for training a fix suggestion pipeline that generates deidentified code flaw fix suggestions. The fix suggestion pipeline is formed with two machine learning models in this illustration, which include a convolutional neural network (CNN) model and a clustering model. Embodiments are not limited to a CNN and a clustering model. For instance, a recurrent neural network and traditional feature learning algorithm can be trained. The resulting trained fix suggestion pipeline includes the program code for the individual models and program code that couples the models. The description of FIG. 5 refers to the remediation service as performing the example operations.

At block 501, the remediation service retrieves labelled training data curated from fixes and corresponding flaws. The fixes and flaws are identified by one or more source file names and timestamps and/or commit identifiers. The fixes and flaws also may indicate the respective source organization.

At block 502, the remediation service begins iterating over each of the flaw/fix pairs. As an example, a repository can index entries by flaw type with references to corresponding instances of the flaw type and corresponding fixes.

At block 503, the remediation service generates a structural context representation that indicates context for the fix and the corresponding flaw. For instance, the remediation service can generate an AST or control flow graph for the fix and corresponding flaw as the structural context representation. In the case of generating an AST for the structural context representation, the remediation service determines a difference between the source code file(s) containing the flaw and the source code file(s) containing the fix. The remediation service then generates an AST from the difference between the flaw source code file(s) and the fix source code file(s). The remediation service can use a tool that parses source code files, determines a difference between the parsed files, and creates an AST therefrom.

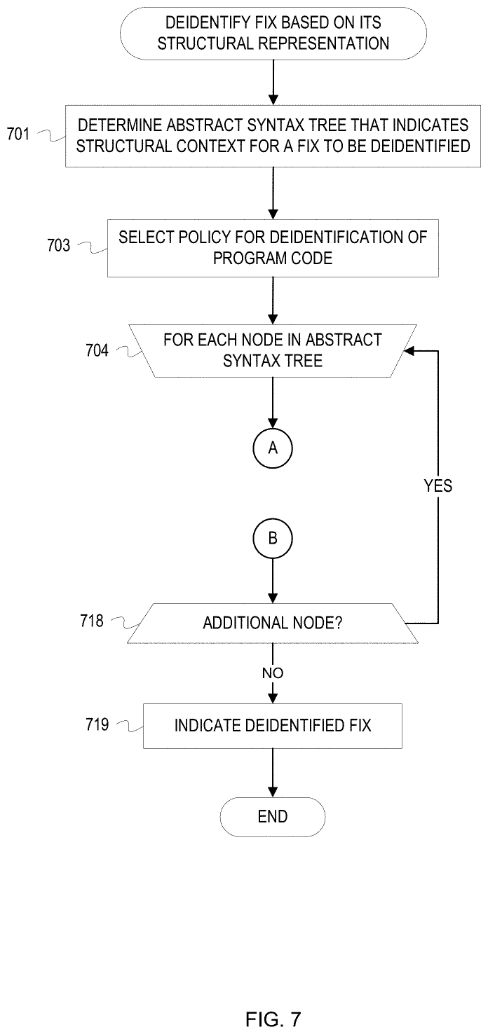

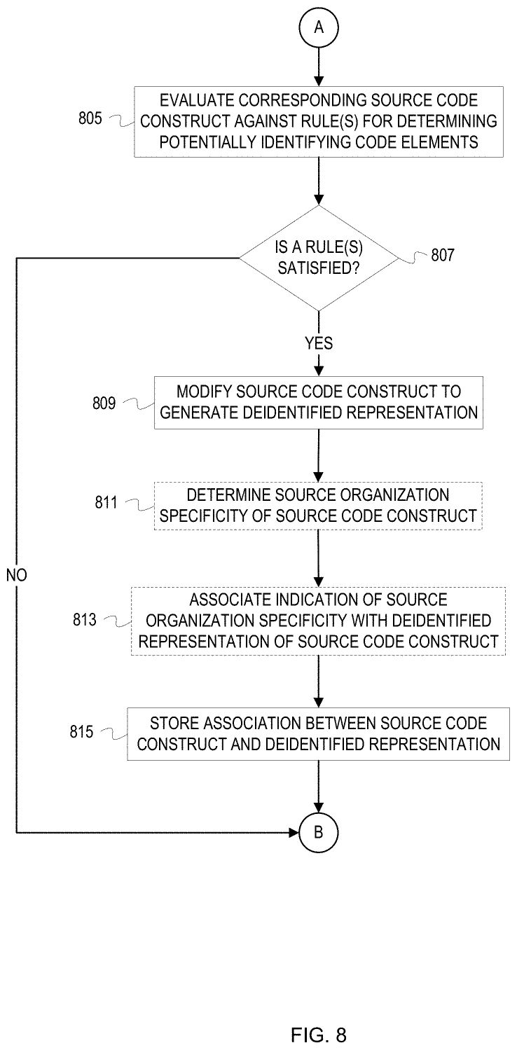

At block 505, the remediation service deidentifies the fix. The remediation service can deidentify the fix based on iterating over each indication of a code element in the structural context representation (e.g., each AST node) and evaluating the corresponding code element against one or more criteria, rules, etc. for determining potentially identifying program code. For example, such criteria or rules may indicate that code elements which do not correspond to an open source code unit(s) or a standard code unit(s) and/or names assigned to code elements (e.g., variable names) constitute potentially identifying program code. Code elements indicated in the structural context representation determined to correspond to potentially identifying program code are deidentified based on modifying the potentially identifying program code, where the modifying removes the potentially identifying information included therein (e.g., through obfuscation, removal and optional replacement with a generic identifier or placeholder, etc.). Deidentification is further described with additional detail in reference to FIGS. 7-8.

At block 507, the remediation service generates a vector representation of the structural context representation. Generating the vector representation allows the structural context to be fed or input into a machine learning model, in this case a CNN. The vector representation also decomposes the structural context information expressed in the structural context representation into features of structural context.

At block 509, the remediation service inputs the vector representation into the CNN to train the CNN to learn features of structural context for the fix and flaw type. The last fully connected layer is a feature vector that is classified by the classification algorithm of the CNN, for example classifications of the feature with a confidence or prediction value per flaw type.

At block 510, the remediation service determines whether there is additional labelled training data to feed into the CNN. If there is additional training data, then operation returns to block 502 to begin preprocessing the next set of training data. If not, then operation flows to block 512. Training of the CNN model can end with iterating over all training data or satisfying the training termination criterion. After training, the trained CNN is saved as the front stage part of the fix suggestion pipeline.

At block 512, the remediation service begins iterating over each of the vector representations generated from the CNN training. These can be generated before training of the models begins. Each of the vector representation is labelled with the flaw type being fixed by the program code represented by the vector representation.

At block 513, the remediation service inputs the vector representation into the trained CNN. The last layer feature vector generated from the trained CNN model is retrieved while the classification can be discarded.

At block 515, the remediation service inputs the feature vector from the trained CNN model into a clustering model. This trains the clustering model to cluster fixes with similar structural context by flaw type.

At bock 516, the remediation service determines whether there is an additional vector representation for training the clustering model. If so, operation returns to block 512 to process the next vector representation. Otherwise, operation continues to block 517 because training of the clustering model is terminated. As with the CNN training, clustering model training terminates when a training termination criterion is satisfied. In some cases, iterating over all of the training data may be the training termination criterion.

At block 517, the remediation service creates a fix suggestion pipeline with the trained CNN model and the trained clustering model. An input vector to the pipeline would be first input into the trained CNN model. A final layer feature vector generated by the trained CNN model is then passed as input into the trained clustering model.

The example operations described in FIG. 5 assume that the training data retrieved for training the fix suggestion model originated from program code belonging to or controlled by an organization. However, training data can also include program code retrieved from public repositories, such as open source repositories. In the cases where flaw/fix data originating from a public repository are used as input during one or more iterations of training and the flaw/fix data thus are not associated with an owning/controlling organization, deidentification operations described at block 505 can be omitted.

FIG. 6 is a flowchart of example operations for obtaining and deidentifying fix suggestions from a trained fix suggestion pipeline. For consistency, FIG. 6 is described with reference to the remediation service.

At block 601, the remediation service generates a structural context representation that indicates context for a detected flaw. For instance, the remediation service can generate an AST or control flow graph for the detected flaw as the structural context representation. In the case of generating an AST for the structural context representation, the remediation service may receive the source file(s) for the detected flaw from an agent which detected the flaw (e.g., as a result of a vulnerability scan). The remediation service may retrieve the source file(s) based on a description of the detected flaw communicated from the agent. Embodiments can program the agent to use a tool to generate the AST or obtain an intermediate representation from a compiler front end.

At block 603, the remediation service generates a vector representation of the structural context representation. The remediation service can use the same word embedding model employed for the pipeline training.

At block 605, the remediation service inputs the vector representation into the trained CNN model. From the trained CNN model, the remediation service obtains a feature vector corresponding to a last layer of the trained CNN model.

At block 607, the remediation service inputs the obtained feature vector into the trained clustering model. The clustering model determines a cluster for the feature vector. Membership of the feature vector in one of the fix structural context clusters indicates similarity of structural context. Although the clustering model was trained with feature vectors of fixes, the feature vectors encoded structural context information of a fix for a flaw type. The feature vector of the flaw will most likely encode a structural context similar to that of one or more fixes for flaws of the same type. This clustering also allows discrimination between fixes of a same flaw type in different structural contexts.

At block 609, the remediation service selects up to M of the nearest neighbors in the determined cluster. The selection limit can be a configuration value communicated from the remediation agent or a parameter of the pipeline.

At block 610, the remediation service iterates over each of the selected cluster members. In particular, the remediation service iterates over each of the M nearest neighbors selected at block 609.

At block 611, the remediation service determines the fix associated with the selected cluster member. The remediation service maintains references or associations between the feature vectors that form the clusters of the trained clustering model and the corresponding program code fixes. The program code fixes can be identified at different granularities. For instance, a program code fix can be identified by source file name, line numbers, and commit identifier (e.g., branch and timestamp). The program code fixes can also be associated with an ID, label, etc. which indicates the respective source organization.

At block 613, the remediation service deidentifies the determined fix. The remediation service determines structural context of the determined fix, such as by obtaining structural context previously determined and stored for the fix during training of the fix suggestion pipeline. The remediation service can deidentify the determined fix based iterating over each indication of a code element in the structural context representation (e.g., each AST node) and evaluating the corresponding code element against one or more criteria, rules, etc. for determining potentially identifying program code. For example, such criteria or rules may indicate that code elements which do not correspond to an open source code unit(s) or a standard code unit(s) and/or names assigned to code elements (e.g., variable names) constitute potentially identifying program code. Code elements indicated in the structural context representation determined to correspond to potentially identifying program code are deidentified based on modifying the potentially identifying program code, where the modifying removes the potentially identifying information included therein (e.g., through obfuscation, removal and optional replacement with a generic identifier or placeholder, etc.). Deidentification is further described with additional detail in reference to FIGS. 7-8.

At block 614, the remediation service determines if the deidentified fix satisfies at least a first organization specificity criterion. Some fix suggestions originating from an organization's program code, such as those utilizing proprietary or internal libraries, may be of limited utility to external organizations. The remediation service may address this by limiting inter-organizational fixes based on at least a first criterion for organization specificity. Organization specificity refers to the specificity of a fix to its source organization. For instance, a fix which includes one or more proprietary or internal code units would have a higher specificity to its source organization, while a fix in which deidentification was limited to obfuscating/removing names given to variables, standard data types, etc. would have a lower specificity to its source organization. The remediation service may evaluate the deidentified fix based on one or more heuristics to determine its organization specificity or identify an organization specificity that was determined for the deidentified fix during deidentification. Organization specificity associated with deidentified fixes may be indicated with a percentage, value, rank, etc. and compared to a threshold, for example, indicated in the criterion. The remediation service can be additionally configured to limit fix suggestions to intra-organization fixes. In this case, if the deidentified fix is associated with a source organization different from that of the detected flaw, the remediation service may determine that the deidentified fix does not satisfy the criterion. If the deidentified fix does not satisfy the organization specificity criterion, operations continue at block 615. If the deidentified fix satisfies the organization specificity criterion, operations continue at block 616.

At block 615, the remediation service removes the fix and selects the next nearest member of the cluster. The remediation service may attempt to replace fixes determined not to satisfy the organization specificity criterion to increase the utility of fixes presented as suggestions while also presenting a total of M fixes. The remediation service can then proceed with determining and deidentifying the associated fix for the next nearest member. The remediation service may track the cumulative number of fix removals and discontinue selection of the next nearest member(s) once a threshold corresponding to a configurable number of removal and replacement instances has been met. As an example, the remediation service may discontinue replacement of removed fixes after the two next nearest members of the cluster have been selected. Any subsequent fixes determined not to satisfy the criterion will then be removed without replacement.

At block 616, the remediation service determines if an additional selected cluster member is remaining. If an additional selected cluster member remains, operations continue at block 610. If there are no selected cluster members remaining, each of the relevant fixes has been deidentified, and operations continue at block 619.

At block 619, the remediation service communicates the deidentified fixes as suggested fixes. The suggested fixes can be communicated to the agent which initially communicated the detected flaw to the remediation service. The remediation service may first assign a rank, priority, etc. to each of the deidentified fixes based on the organization specificity of the fixes before the fixes are communicated as suggestions. The remediation service may also account for the respective source organization of the deidentified fixes when assigning the rank or priority. For instance, the remediation service can associate a highest priority or rank with deidentified fixes for which the respective source organization is the same as the organization affiliated with the detected flaw, while deidentified fixes affiliated with peer organizations can be associated with a lower rank or priority.

In FIG. 6, the example operations describe prediction-stage deidentification of fixes, which can occur if the fix suggestion pipeline is not trained with deidentified flaw/fix training data. In implementations in which the fix suggestion pipeline was trained with deidentified flaw/fix training data and the trained fix suggestion pipeline thus outputs deidentified fixes, the deidentification operations described in FIG. 6 can be omitted during retrieval of suggested fixes for a flaw from the trained fix suggestion pipeline. For instance, the remediation service can omit the deidentification operations described at block 613.

The example operations in FIG. 6 also describe deidentifying each of the fixes associated with the selected cluster members. In some implementations, the remediation service can determine whether the fixes determined at block 611 are intra-organization fixes. The remediation service may be configurable to allow intra-organization fixes to bypass deidentification such that the intra-organization fixes included in the suggested fixes maintain their original representations (i.e., are not deidentified). In such cases, upon determining that a fix determined at block 611 is an intra-organization fix, the deidentification operations described at blocks 613 and 614 can be omitted for the determined intra-organization fix.

FIGS. 7-8 are a flowchart of example operations for deidentifying a fix based on its structural representation. The example operations refer to a remediation service as performing the depicted operations for consistency with the earlier figures. The functionality of the remediation service described in FIGS. 7-8 can be invoked during training of a fix suggestion pipeline to deidentify training data input into the fix suggestion pipeline or after a trained fix suggestion pipeline outputs fix predictions to deidentify the fixes (e.g., as described in reference to FIG. 5 and FIG. 6, respectively). FIGS. 7-8 also describe determining an AST that indicates structural context for a fix. Embodiments are not limited to determining structural context for a fix based on determining an AST. For instance, a control flow graph which indicates structural context for the fix can be determined.

At block 701, the remediation service determines an AST that indicates structural context for a fix to be deidentified. The process by which the AST is determined can vary depending on whether the remediation service is deidentifying a fix to be used as training data during training of a fix suggestion pipeline or deidentifying a fix prediction output by the trained fix suggestion pipeline before communicating the fix as a suggested fix. During training stage deidentification, the remediation service determines the AST by generating an AST for the fix, such as based on determining differences between a source code file(s) of the fix and a source code file(s) of a corresponding flaw. During prediction stage deidentification, the remediation service can determine an AST based on obtaining an AST previously determined and stored for the fix during training of the fix suggestion pipeline.

At block 703, the remediation service selects a policy for deidentification of program code. The policy indicates the process or technique for removing potentially identifying information from program code. For instance, the policy may indicate that potentially identifying program code of the fix is to be deidentified based on obfuscating the program code, removing the program code, or removing and replacing the program code with a placeholder or identifier. The deidentification policy that is to be used may be a configuration setting of the remediation service.

At block 704, the remediation service begins iterating over each node in the AST. Each of the nodes in the AST corresponds to a source code construct occurring in program code of the fix. Values of each of the source code constructs may be denoted in a property, attribute, value, etc. of the corresponding node. Operations continue to transition point A, which continues at block 805 of FIG. 8.

At block 805, the remediation service evaluates the source code construct corresponding to the node against one or more rules for determining code elements which are potentially identifying of a source organization of the fix. The remediation service can, for instance, evaluate a value(s) of at least a first node property, attribute, etc. against the rules. The rules may indicate that code elements (e.g., source code constructs indicated in AST nodes) that do not correspond to an open source code unit(s) or standard code unit(s) should be considered potentially identifying of their respective source. As an example, the rules may indicate a listing of “known” code units, including open source code units and standard code units, which do not identify a particular organization or other source. The rules can then dictate that code elements corresponding to a code unit(s) that cannot be identified in the listing of known code units are to be determined to include potentially identifying information. Alternatively or in addition, the rules may indicate that naming conventions used for code elements should be considered potentially identifying of the respective source (e.g., variable names, class names, routine/subroutine names, etc.).

At block 807, the remediation service determines if at least a first rule is satisfied. At least a first of the rules can be satisfied if the source code construct corresponding to the node is determined not to correspond to an open source code unit(s) or standard code unit(s) and/or if the source code construct includes a name assigned by a member of the source organization, for example. If a rule is satisfied, operations continue at block 809. If no rules are satisfied, operations continue to transition point B, which continues at block 718 of FIG. 7.

At block 809, the remediation service modifies the source code construct to generate a deidentified representation. The remediation service modifies the source code construct according to the selected deidentification policy. For instance, if the policy indicated that code is to be modified through obfuscation, the remediation service can obfuscate the potentially identifying information indicated by source code construct (e.g., by generating a randomly generated string of characters which will replace the potentially identifying information). If the policy indicated that code is to be modified through removal and replacement, the remediation service can determine a placeholder or identifier with which to replace the potentially identifying code. As an example, the remediation service can determine a type of the source code construct and replace the source code construct with a generic identifier indicating the type. The remediation service may determine the type of the source code construct based on a set of mappings between source code constructs of the source organization and corresponding types previously determined and generated that is accessible to the remediation service.

At block 811, the remediation service determines a source organization specificity of the source code construct. The source organization specificity indicates the degree to which the source code construct is specific to its source organization. The remediation service can determine a value, score, or other metric for the source code construct indicating specificity to its source organization based on a set of heuristics, for example. The heuristics may indicate that source code constructs having a higher degree of source organization specificity can include those associated with proprietary or internal code units, while source code constructs having a low degree of source organization specificity can include names used for variables, classes, routines/subroutines, etc. The remediation service can evaluate the source code construct based on the heuristics and determine a corresponding value, score, etc. indicative of degree of specificity to its source organization to be assigned to its deidentified representation. As an example, heuristics can be implemented such that code elements and features thereof are associated with a corresponding specificity score. The remediation service can then assign the source code construct a default specificity value of zero and evaluate of the source code construct based on the heuristics, increasing the score as needed. The remediation service may also maintain a cumulative source organization specificity for the fix that is updated upon each specificity determination instance based on the determined source organization specificity of each deidentified source code construct.

At block 813, the remediation service associates an indication of the source organization specificity with the deidentified representation of the source code construct. The remediation service can associate a label, tag, etc. indicating the source organization specificity with the deidentified representation.

At block 815, the remediation service stores an association between an indication of the source code construct and an indication of its deidentified representation. The remediation service can insert the association along with the organization ID in a repository that stores associations between source code constructs and their deidentified representations (e.g., a relational database). The remediation service may assign a label, tag, ID, etc. unique to the deidentified representation for the organization ID prior to insertion into the repository. The remediation service can therefore access the association during subsequent presentation of deidentified fix suggestions from the repository based on organization IDs and/or deidentified representations of source code constructs so that original representations can be presented to users within the organization from which the deidentified fix suggestion originated. The repository may also be queried during subsequent deidentification operations (e.g., at block 809) to determine whether a deidentified representation of a source code construct corresponding to an AST node has already been generated. Operations continue to transition point B, which continues at block 718 of FIG. 7.

At block 718, the remediation service determines if an additional node of the AST is remaining. If there is an additional node remaining, operations continue at block 704. If there are no nodes of the AST remaining, operations continue at block 719.

At block 719, the remediation service indicates the deidentified fix. If one or more source organization specificities were determined during deidentification of the fix, the remediation service can indicate an aggregate of the source organization specificities with the deidentified fix. For instance, the remediation service can indicate the cumulative source organization specificity resulting from deidentification along with the deidentified fix. The aggregate source organization specificity can be leveraged to inform a determination of whether to later present the fix as a fix suggestion based on one or more organization specificity criteria (e.g., as described in reference to FIG. 6 at block 614).

Variations

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the operations depicted in blocks 704 to 718 can be performed in parallel or concurrently for each of the nodes. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

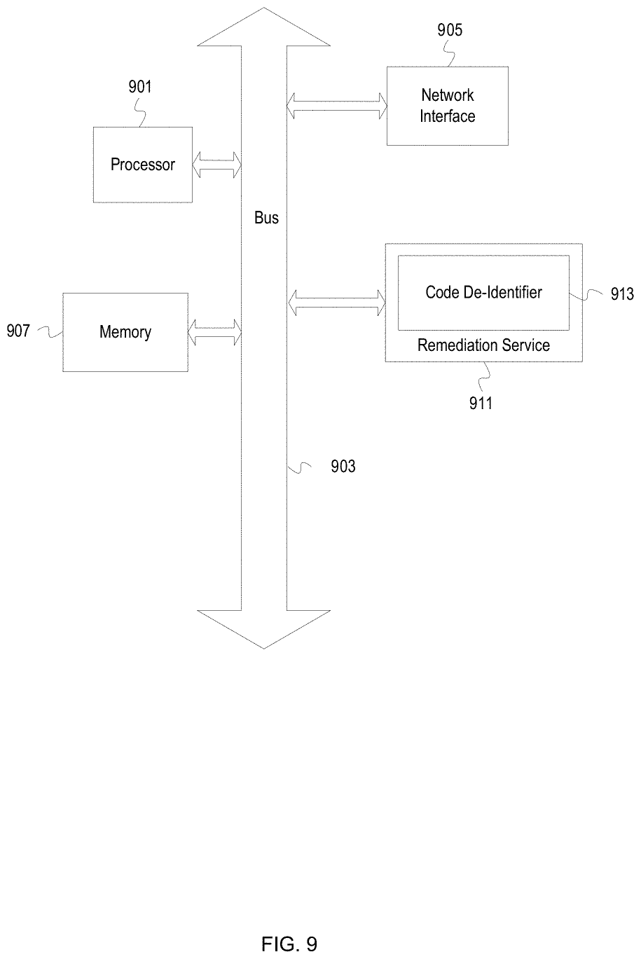

FIG. 9 depicts an example computer system with a remediation service that includes a code de-identifier. The computer system includes a processor 901 (possibly including multiple processors, multiple cores, multiple nodes, and/or implementing multi-threading, etc.). The computer system includes memory 907. The memory 907 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 903 (e.g., PCI, ISA, PCI-Express, HyperTransport® bus, InfiniBand® bus, NuBus, etc.) and a network interface 905 (e.g., a Fiber Channel interface, an Ethernet interface, an internet small computer system interface, SONET interface, wireless interface, etc.). The system also includes remediation service 911 with code de-identifier 913. The remediation service 911 trains a fix suggestion machine learning model pipeline with multi-organization flaw/fix training data and provides suggested fixes to flaws detected in a software project based on running the trained fix suggestion machine learning model pipeline with detected flaws as input. The remediation service 911 invokes the code de-identifier 913 to deidentify flaw/fix training data and/or program code fixes output by the trained fix suggestion machine learning model pipeline based on modification of the program code determined to include information which potentially identifies the owning/controlling organization of the respective program code. Any one of the previously described functionalities may be partially (or entirely) implemented in hardware and/or on the processor 901. For example, the functionality may be implemented with an application specific integrated circuit, in logic implemented in the processor 901, in a co-processor on a peripheral device or card, etc. Further, realizations may include fewer or additional components not illustrated in FIG. 9 (e.g., video cards, audio cards, additional network interfaces, peripheral devices, etc.). The processor 901 and the network interface 905 are coupled to the bus 903. Although illustrated as being coupled to the bus 903, the memory 907 may be coupled to the processor 901.

While the aspects of the disclosure are described with reference to various implementations and exploitations, it will be understood that these aspects are illustrative and that the scope of the claims is not limited to them. In general, techniques for deidentification of program code for cross-organization remediation knowledge as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

### EXAMPLE EMBODIMENTS

Example embodiments include the following:

Embodiment 1: A method comprises obtaining a program code fix to a flaw identified in a software project, wherein the program code fix is associated with a first organization. Structural context of the program code fix is determined. It is determined if the program code fix comprises program code that is potentially identifying of the first organization based, at least in part, on the structural context of the program code fix. Based on determining that the program code fix comprises program code that is potentially identifying of the first organization, the program code fix is deidentified based, at least in part, on modifying the potentially identifying program code.

Embodiment 2: The method of Embodiment 1, wherein determining structural context of the program code fix comprises determining an abstract syntax tree of the program code fix or a control flow graph of the program code fix.

Embodiment 3: The method of Embodiment 2, wherein determining the abstract syntax tree of the program code fix comprises determining the abstract syntax tree based, at least in part, on differences between source code of the flaw and source code of the program code fix.

Embodiment 4: The method of Embodiments 2 or 3, wherein determining if the program code fix comprises program code that is potentially identifying of the first organization comprises, evaluating nodes of the structural context of the program code fix against one or more rules for determining potentially identifying program code; and determining if at least a first of the nodes satisfies a first of the one or more rules.

Embodiment 5: The method of Embodiment 4, wherein the one or more rules comprise rules to determine that program code is potentially identifying if the program code does not correspond to standard code units or open source code units.

Embodiment 6: The method of one of Embodiments 1-5, wherein modifying the potentially identifying program code comprises obfuscating or removing at least a first source code construct corresponding to the potentially identifying program code, wherein the obfuscating or removing generates a deidentified representation of the first source code construct.

Embodiment 7: The method of Embodiment 6, wherein removing the first source code construct comprises determining an indication of a type of the first source code construct and replacing the first source code construct with the indication of the type.

Embodiment 8: The method of Embodiments 6 or 7, further comprising generating and storing an association between the first source code construct and the deidentified representation, wherein the association also identifies the first organization.

Embodiment 9: The method of one of Embodiments 1-8, wherein obtaining the program code fix to the flaw comprises obtaining the program code fix to the flaw from a repository of labelled program code fixes and corresponding flaws.

Embodiment 10: The method of one of Embodiments 1-9, further comprising determining one or more suggested program code fixes to the flaw, wherein obtaining the program code fix to the flaw comprises obtaining the program code fix from the one or more suggested program code fixes.

Embodiment 11: One or more non-transitory machine-readable media comprising program code for deidentifying a program code fix associated with a first organization, the program code to: generate a structural representation of the fix, wherein the structural representation indicates a plurality of source code constructs; determine whether at least a first source code construct of the plurality of source code constructs includes information which is potentially identifying of the first organization based, at least in part, on the structural representation of the fix; and based on a determination that the first source code construct includes information that is potentially identifying of the first organization, modify the first source code construct, wherein the modification of the first source code construct removes or obfuscates the potentially identifying information.

Embodiment 12: The non-transitory machine-readable media of Embodiment 11, wherein the program code to determine whether the first source code construct is potentially identifying of the first organization comprises program code to determine whether the first source code construct does not correspond to one or more standard code units or one or more open source code units.

Embodiment 13: The non-transitory machine-readable media of Embodiments 11 or 12, wherein the program code to remove the potentially identifying information comprises program code to replace the first source code construct with an identifier that indicates a type of the first source code construct.

Embodiment 14: The non-transitory machine-readable media of one of Embodiments 11-13, wherein the program code to generate the structural representation of the fix comprises program code to generate an abstract syntax tree of the fix, wherein the abstract syntax tree comprises a plurality of nodes, wherein each of the plurality of nodes corresponds to a respective one of the plurality of source code constructs.

Embodiment 15: An apparatus comprises a processor and a machine-readable medium. The machine-readable medium has program code executable by the processor to cause the apparatus to obtain one or more program code fixes to a flaw identified in a software project, wherein each of the program code fixes is associated with a corresponding one of a plurality of source organizations, and wherein the software project is associated with a first organization. The program code is also executable by the processor to cause the apparatus to, for each program code fix of the one or more program code fixes and corresponding one of the plurality of source organizations, determine a structural context of the program code fix; determine if the program code fix comprises program code that is potentially identifying of the corresponding one of the plurality of source organizations based, at least in part, on the structural context of the program code fix; and based on a determination that the program code fix comprises program code that is potentially identifying of the corresponding one of the plurality of source organizations, deidentify the program code fix based, at least in part, on modification of the potentially identifying program code.

Embodiment 16: The apparatus of Embodiment 15, wherein the program code executable by the processor to cause the apparatus to determine the structural context of the program code fix comprises program code executable by the processor to cause the apparatus to determine an abstract syntax tree or control flow graph of the program code fix.

Embodiment 17: The apparatus of Embodiment 16, wherein the program code executable by the processor to cause the apparatus to determine if the program code fix comprises program code that is potentially identifying of the corresponding source organization comprises program code executable by the processor to cause the apparatus to evaluate nodes of the abstract syntax tree or control flow graph against one or more rules for determining potentially identifying program code.

Embodiment 18: The apparatus of Embodiment 17, further comprising program code executable by the processor to cause the apparatus to determine that the program code fix comprises program code that is potentially identifying of the corresponding source organization based, at least in part, on at least a first of the nodes satisfying a first of the one or more rules, wherein the one or more rules comprise rules to determine that program code is potentially identifying if the program code does not correspond to one or more standard code units or one or more open source code units.

Embodiment 19: The apparatus of one of Embodiments 15-18, wherein the determination of structural context, determination if the program code fix comprises program code that is potentially identifying of the corresponding one of the plurality of source organizations, and deidentification of the potentially identifying program code for each program code fix generates a plurality of deidentified program code fixes.

Embodiment 20: The apparatus of Embodiment 19, further comprising program code executable by the processor to cause the apparatus to, for each of the plurality of deidentified program code fixes, determine if the corresponding one of the plurality of source organizations is the same as the first organization; and based on a determination that the corresponding one of the plurality of source organizations is the same as the first organization, associate, with the deidentified program code fix, a rank or indication that the deidentified program code fix is a high priority fix.

What is claimed is:

1. A method comprising:
obtaining a program code fix to a flaw identified in a software project, wherein the program code fix is associated with a first organization;
determining structural context of the program code fix;
determining if the program code fix comprises program code that is potentially identifying of the first organization based, at least in part, on the structural context of the program code fix; and
based on determining that the program code fix comprises program code that is potentially identifying of the first organization, deidentifying the program code fix based, at least in part, on modifying the potentially identifying program code.

2. The method of claim 1, wherein determining structural context of the program code fix comprises determining an abstract syntax tree of the program code fix or a control flow graph of the program code fix.

3. The method of claim 2, wherein determining the abstract syntax tree of the program code fix comprises determining the abstract syntax tree based, at least in part, on differences between source code of the flaw and source code of the program code fix.

4. The method of claim 2, wherein determining if the program code fix comprises program code that is potentially identifying of the first organization comprises,
evaluating nodes of the structural context of the program code fix against one or more rules for determining potentially identifying program code; and
determining if at least a first of the nodes satisfies a first of the one or more rules.

5. The method of claim 4, wherein the one or more rules comprise rules to determine that program code is potentially identifying if the program code does not correspond to standard code units or open source code units.

6. The method of claim 1, wherein modifying the potentially identifying program code comprises obfuscating or removing at least a first source code construct corresponding to the potentially identifying program code, wherein the obfuscating or removing generates a deidentified representation of the first source code construct.

7. The method of claim 6, wherein removing the first source code construct comprises determining an indication of a type of the first source code construct and replacing the first source code construct with the indication of the type.

8. The method of claim 6, further comprising generating and storing an association between the first source code construct and the deidentified representation, wherein the association also identifies the first organization.

9. The method of claim 1, wherein obtaining the program code fix to the flaw comprises obtaining the program code fix to the flaw from a repository of labelled program code fixes and corresponding flaws.

10. The method of claim 1, further comprising determining one or more suggested program code fixes to the flaw, wherein obtaining the program code fix to the flaw comprises obtaining the program code fix from the one or more suggested program code fixes.

11. One or more non-transitory machine-readable media comprising program code for deidentifying a program code fix associated with a first organization, the program code to:
generate a structural representation of the fix, wherein the structural representation indicates a plurality of source code constructs;
determine whether at least a first source code construct of the plurality of source code constructs includes information which is potentially identifying of the first organization based, at least in part, on the structural representation of the fix; and
based on a determination that the first source code construct includes information that is potentially identifying of the first organization, modify the first source code construct, wherein the modification of the first source code construct removes or obfuscates the potentially identifying information.

12. The non-transitory machine-readable media of claim 11, wherein the program code to determine whether the first source code construct is potentially identifying of the first organization comprises program code to determine whether the first source code construct does not correspond to one or more standard code units or one or more open source code units.

13. The non-transitory machine-readable media of claim 11, wherein the program code to remove the potentially identifying information comprises program code to replace the first source code construct with an identifier that indicates a type of the first source code construct.

14. The non-transitory machine-readable media of claim 11, wherein the program code to generate the structural representation of the fix comprises program code to generate an abstract syntax tree of the fix, wherein the abstract syntax tree comprises a plurality of nodes, wherein each of the plurality of nodes corresponds to a respective one of the plurality of source code constructs.

15. An apparatus comprising:
a processor; and
a machine-readable medium having program code executable by the processor to cause the apparatus to,
obtain one or more program code fixes to a flaw identified in a software project,
wherein each of the program code fixes is associated with a corresponding one of a plurality of source organizations,
wherein the software project is associated with a first organization;
for each program code fix of the one or more program code fixes and corresponding one of the plurality of source organizations, determine a structural context of the program code fix;
determine if the program code fix comprises program code that is potentially identifying of the corresponding one of the plurality of source organizations based, at least in part, on the structural context of the program code fix; and
based on a determination that the program code fix comprises program code that is potentially identifying of the corresponding one of the plurality of source organizations, deidentify the program code fix based, at least in part, on modification of the potentially identifying program code.

16. The apparatus of claim 15, wherein the program code executable by the processor to cause the apparatus to determine the structural context of the program code fix comprises program code executable by the processor to cause the apparatus to determine an abstract syntax tree or control flow graph of the program code fix.

17. The apparatus of claim 16, wherein the program code executable by the processor to cause the apparatus to determine if the program code fix comprises program code that is potentially identifying of the corresponding source organization comprises program code executable by the processor to cause the apparatus to evaluate nodes of the abstract syntax tree or control flow graph against one or more rules for determining potentially identifying program code.

18. The apparatus of claim 17, further comprising program code executable by the processor to cause the apparatus to determine that the program code fix comprises program code that is potentially identifying of the corresponding source organization based, at least in part, on at least a first of the nodes satisfying a first of the one or more rules, wherein the one or more rules comprise rules to determine that program code is potentially identifying if the program code does not correspond to one or more standard code units or one or more open source code units.

19. The apparatus of claim 15, wherein the determination of structural context, determination if the program code fix comprises program code that is potentially identifying of the corresponding one of the plurality of source organizations, and deidentification of the potentially identifying program code for each program code fix generates a plurality of deidentified program code fixes.

20. The apparatus of claim 19, further comprising program code executable by the processor to cause the apparatus to, for each of the plurality of deidentified program code fixes,
determine if the corresponding one of the plurality of source organizations is the same as the first organization; and
based on a determination that the corresponding one of the plurality of source organizations is the same as the first organization, associate, with the deidentified program code fix, a rank or indication that the deidentified program code fix is a high priority fix.
